(19) United States
(12) Patent Application Publication
(10) Pub. No.: US 2024/0384775 A1
(43) Pub. Date: Nov. 21, 2024

(54) HYDRAULIC DAMPER

(71) Applicant: Fox Factory, Inc., Duluth, GA (US)

(72) Inventor: Matthew Stewart, Buford, GA (US)

(73) Assignee: Fox Factory, Inc., Duluth, GA (US)

(21) Appl. No.: 18/615,175

(22) Filed: Mar. 25, 2024

Related U.S. Application Data
(60) Provisional application No. 63/466,503, filed on May 15, 2023.

(51) Int. Cl. F16F 9/516; F15B 15/16; F15B 15/24; F16F 9/06; F16F 9/32; F16F 9/58; F16F 13/00

(52) U.S. Cl. CPC F16F 9/516; F15B 15/16; F15B 15/24; F16F 9/064; F16F 9/3214; F16F 9/3221; F16F 9/58; F16F 13/007; F16F 2222/12; F16F 2228/066; F16F 2230/36; F16F 2230/42

(57) ABSTRACT

Disclosed herein is a hydraulic damper comprising a damper body comprising a chamber, a shaft telescopically engaged with the damper body, and a piston slidably disposed with the damper body and coupled to a first end of the shaft, the piston comprising an orifice for fluidly connecting the chamber to an interior of the shaft, wherein the orifice comprises a first flow inlet having a first edge profile and a second flow inlet having a second edge profile such that fluid flowing through the orifice from the first flow inlet toward the second flow inlet exhibits a different pressure drop than fluid flowing through the orifice from the second flow inlet to the first flow inlet.

### CROSS-REFERENCE TO RELATED APPLICATIONS (PROVISIONAL)

This application claims priority to and the benefit of co-pending U.S. Provisional Patent Application No. 63/466,503 filed on May 15, 2023, entitled “DIRECTION DIFFERENTIAL ORIFICE” by Matthew Stewart, and assigned to the assignee of the present application, the disclosure of which is hereby incorporated by reference in its entirety.

### BACKGROUND ART

In bike and vehicular suspension, a bump stop may be used during instances of possible suspension bottoming out. When the suspension bottoms out, or is fully compressed, the suspension and even the vehicle frame can be damaged. Bottom out events can lead to a loss of vehicle control and discomfort experienced by the vehicle occupants. Bump stops act to prevent full bottoming out, and as a result protect the suspension system and frame of the vehicle or bike. This increased bottom out control contributes to increased occupant safety and comfort.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 shows a cross section view of hydraulic bump stop, according to an embodiment.

FIG. 2A shows a close-up cross section view of the piston, according to a first embodiment.

FIG. 2B shows a close-up cross section view of the piston, according to a second embodiment.

FIG. 3 shows close-up cross section view of the piston, according to a generalized embodiment.

### DETAILED DESCRIPTION OF THE EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

When fitting suspension and bump stop systems to a vehicle or bike, there is often a limited amount of space for the components to fit into. As a result, it is important to make the damper as compact as possible, while still retaining the functionality of non-compact embodiments.

Hydraulic dampers, such as bump stops, are always a compromise between stroke and overall length. This has significant impact on mounting options and locations as well as tuning limitations. If dead length can be decreased, the stroke for a given compressed length can be increased, greatly improving packaging efficiency.

Due to the space constraints, current bump stop designs use orifice damping for controlling compression and rebound of the components. However, one drawback of this design is that the compression and rebound cannot be independently tuned. As such, the rebound shaft speed is a result of the compression damping force and therefore allows some energy to be put back into the system by the bump stop on the rebound stroke.

Embodiments described herein lessen the aforementioned shortcomings of conventional bump stop and hydraulic damper designs by utilizing a direction differential orifice that provides a different pressure drop in a compression event versus a rebound event, thus providing the ability to tune between compression events and rebound events using a single component and no moving parts.

The described embodiments provide a solution to the need for a stroke efficient external bump stop configuration where there is limited allowable packaging space. The described embodiments utilize an orifice damping bump stop design in which an inlet condition in the compression direction minimizes flow separation and therefore increases the effective flow area. By doing this, the actual through hole diameter can be reduced which therefore lowers the rebound shaft speed. By tuning the efficiency of the inlet edge condition, the differential in pressure drop through the piston can be tuned in either direction. For example, the described embodiments may provide up to a ˜15% reduction of rebound shaft speed for a given compression damping force.

The hydraulic damper described herein uses a piston with orifice bleed to generate damping force. The described embodiments can maximize the difference in pressure drop across the piston in one direction versus the other. This affords the ability to have a piston that behaves differently in compression and rebound without the use of any additional components by creating an orifice design with different effective flow areas in each direction. For example, on a bump stop, rebound force can be minimized for a compression force.

Embodiments described herein provide a hydraulic damper that provides different pressure drops in the compression and rebound directions by utilizing an orifice geometry that is different in each direction. For example, in accordance with some embodiments, the inlet of the orifice through which fluid flows during a compression event has a curved edge and the inlet of the orifice through which fluid flows during a rebound event has a straight edge. In some embodiments, the curved edge inlet has an elliptical edge. For purposes of clarity and brevity the following description will refer to the present orifice configuration in a piston however, the present orifice configuration is well suited to use with any flow control device where directional differentiation is desired.

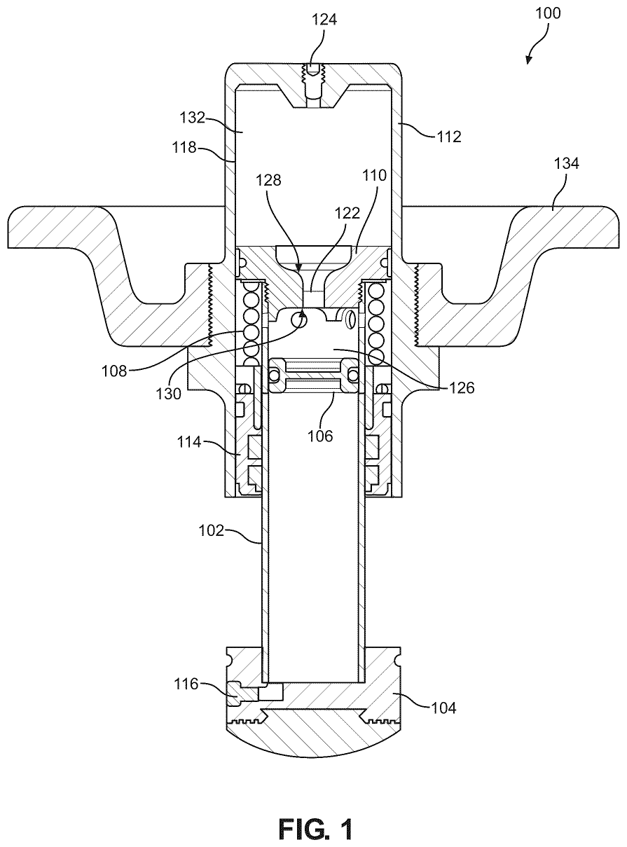

FIG. 1 shows a cross section view of hydraulic bump stop 100, according to an embodiment. Hydraulic bump stop 100 is comprised of shaft 102, bottom bumper 104, internal floating piston 106, negative spring 108, piston 110, mounting bracket 134, and damper body 112. It should be appreciated that negative spring 108 may include any number of coils in order to control dead length. Dead length is the length of hydraulic bump stop 100 that does not contribute to active damper travel.

Bearing housing 114 houses the bearings, seals, and similar components. Negative spring 108 is disposed between shaft 102 and damper body 112. Shaft 102 is telescopically engaged with damper body 112, and piston 110 is slidably disposed within the damper body 112 and coupled to a first end of shaft 102. In some embodiments, damper body 112 is threadedly coupled to the first end of shaft 102. Bottom bumper 104 is disposed at a second end of shaft 102.

The interior of shaft 102 is loaded with a gas (e.g., nitrogen). In one embodiment, gas charge 116 is in gas communication with the interior of shaft 102 through bottom bumper 104 for adding gas to the interior of shaft 102. Compression chamber 132 and rebound chamber 126 are loaded with a fluid. (e.g., oil or another hydraulic fluid). In one embodiment, the fluid is loaded into compression chamber 132 through fluid port 124. In some embodiments, fluid port 124 extends into compression chamber 132. In other embodiments, fluid port 124 is flush with the surface of compression chamber 132.

Piston 110 is slidably disposed within damper body 112 and divides the damper body 112 into compression chamber 132 and rebound chamber 126. Rebound chamber 126 is disposed within the interior of shaft 102. Compression chamber 132 is fluidly connected to rebound chamber 126 via damping orifice 122.

During operation of hydraulic bump stop 100, compression and rebound events occur during instances of possible suspension bottoming out. A compression event occurs when a vehicle suspension makes contact with bottom bumper 104 and compresses shaft 102 into damper body 112. During a compression event, the overall length of hydraulic bump stop 100 is reduced, as shaft 102 slides into damper body 112. During a compression event, hydraulic fluid flows through damping orifice 122 from compression chamber 132 into rebound chamber 126.

A rebound event occurs when the suspension or object contacting bottom bumper 104 moves away from bottom bumper 104, allowing shaft 102 to extend out of damper body 112. During a rebound event, the overall length of hydraulic bump stop 100 increases, as shaft 102 slides out of damper body 112. During a rebound event, hydraulic fluid flows through damping orifice 122 from rebound chamber 126 into compression chamber 132.

Orifice 122 includes a first flow inlet 128 facing compression chamber 132 and a second flow inlet 130 facing rebound chamber 126. First flow inlet 128 and second flow inlet 130 have different edge profiles such that fluid flowing through orifice 122 from compression chamber 132 through first flow inlet 128 toward second flow inlet 130 exhibits a different pressure drop than fluid flowing through orifice 122 from rebound chamber 126 through second flow inlet 130 toward first flow inlet 128.

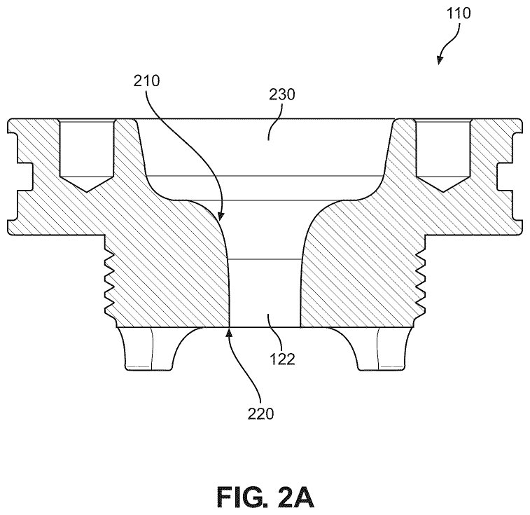

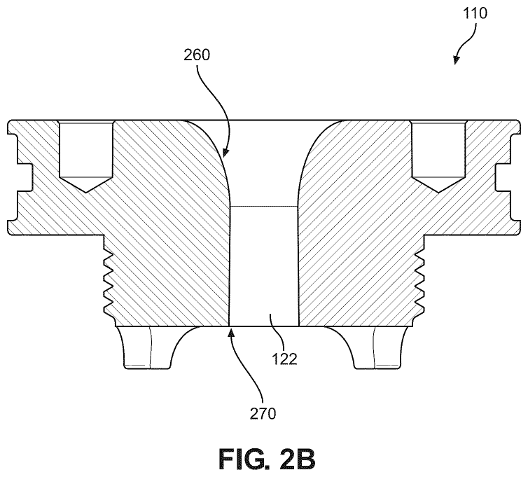

FIGS. 2A and 2B illustrate examples of piston 110 including orifice 122 in which first flow inlet 128 and second flow inlet 130 have different edge profiles. FIG. 2A shows a close-up cross section view of piston 110, according to a first embodiment. Piston 110 includes orifice 122, through which fluid can flow between compression chamber 132 and rebound chamber 126. Orifice 122 includes first flow inlet 210 and second flow inlet 220.

First flow inlet 210 has a curved edge profile and second flow inlet 220 has a square edge profile. In some embodiments, the curved edge profile of first flow inlet 210 has an elliptical cross-sectional shape. As such, first flow inlet 210 and second flow inlet 220 have different edge profiles such that fluid flowing through orifice 122 from compression chamber 132 through first flow inlet 210 toward second flow inlet 220 exhibits a different pressure drop than fluid flowing through orifice 122 from rebound chamber 126 through second flow inlet 220 toward first flow inlet 210.

In the illustrated embodiment, piston 110 includes cavity 230 through which fluid flows during compression and rebound events. Cavity 230 is adjacent to first flow inlet 210. It should be appreciated that cavity 230 does not contribute to the characteristics of fluid flow through orifice 122 in either direction. For example, cavity 230 allows for full compression of shaft 102 into damper body 112 where fluid port 124 extends into compression chamber 132, as illustrated in FIG. 1.

FIG. 2B shows a close-up cross section view of piston 110, according to a second embodiment. Piston 110 includes orifice 122, through which fluid can flow between compression chamber 132 and rebound chamber 126. Orifice 122 includes first flow inlet 260 and second flow inlet 270.

First flow inlet 260 has a curved edge profile and second flow inlet 270 has a square edge profile. In some embodiments, the curved edge profile of first flow inlet 260 has an elliptical cross-sectional shape. As such, first flow inlet 260 and second flow inlet 270 have different edge profiles such that fluid flowing through orifice 122 from compression chamber 132 through first flow inlet 260 toward second flow inlet 270 exhibits a different pressure drop than fluid flowing through orifice 122 from rebound chamber 126 through second flow inlet 270 toward first flow inlet 260.

In the illustrated embodiment, first flow inlet 260 is flush with surface 262 of piston 110, where surface 262 faces compression chamber 132. The illustrated embodiment allows for full compression of shaft 102 into damper body 112 where fluid port 124 is flush with the opposing surface of damper body 112.

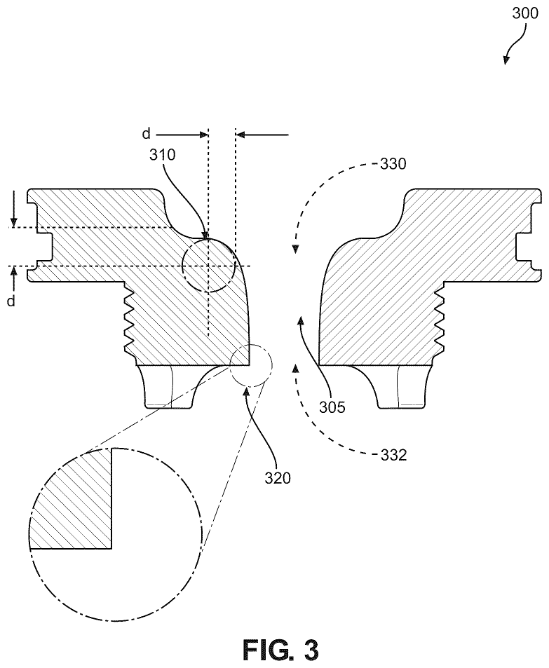

FIG. 3 shows a close-up cross section view of piston 300, according to a generalized embodiment. It should be appreciated that piston 300 can be used as piston 110 of FIG. 1. Piston 300 includes orifice 305, through which fluid can flow between a compression chamber (e.g., compression chamber 132 of FIG. 1) and a rebound chamber (e.g., rebound chamber 126). Orifice 305 includes first flow inlet 310 and second flow inlet 320.

First flow inlet 310 has a curved edge profile and second flow inlet 320 has a square edge profile. In some embodiments, the curved edge profile of first flow inlet 210 has an elliptical cross-sectional shape. As such, first flow inlet 310 and second flow inlet 320 have different edge profiles such that fluid flowing through orifice 305 through first flow inlet 310 toward second flow inlet 320 (as shown as compression flow 330) exhibits a different pressure drop than fluid flowing through orifice 305 from second flow inlet 320 toward first flow inlet 310 (as shown as rebound flow 332).

Orifice 305 of piston 300 provides a hydraulic damper that provides different pressure drops in the compression and rebound directions by utilizing an orifice geometry that is different in each direction. In some embodiments, an orifice with a flow inlet having an elliptical edge profile is equivalent to a larger flow inlet having a square edge profile in the compression direction. For example, in accordance with the illustrated embodiment, a 0.270 inch orifice with a flow inlet having an elliptical edge profile is equivalent to a 0.300 flow inlet having a square edge profile in the compression direction. This corresponds to a rebound force decrease of ˜51 pounds of force at a rebound shaft speed of 20 inches per second. Moreover, an orifice with a flow inlet having an elliptical edge profile also reduces swish noise during high speed compression events.

While discussed in the context of a hydraulic bump stop, the listed improvements of the above embodiments are universal enough to be used in other applications. For example, components of the present invention may be used in a shock absorber.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A hydraulic damper comprising:
a damper body comprising a chamber; and
a shaft telescopically engaged with the damper body; and
a piston slidably disposed with the damper body and coupled to a first end of the shaft, the piston comprising an orifice for fluidly connecting the chamber to an interior of the shaft, wherein the orifice comprises a first flow inlet having a first edge profile and a second flow inlet having a second edge profile such that fluid flowing through the orifice from the first flow inlet toward the second flow inlet exhibits a different pressure drop than fluid flowing through the orifice from the second flow inlet to the first flow inlet.

2. The hydraulic damper of claim 1, wherein the first edge profile is a curved edge profile.

3. The hydraulic damper of claim 2, wherein the curved edge profile is an elliptical edge profile.

4. The hydraulic damper of claim 1, wherein the second edge profile is a square edge profile.

5. The hydraulic damper of claim 1, wherein fluid flows through the orifice from the first flow inlet toward the second flow inlet during a compression event.

6. The hydraulic damper of claim 1, wherein fluid flows through the orifice from the second flow inlet to the first flow inlet during a rebound event.

7. The hydraulic damper of claim 1, further comprising a bumper disposed at a second end of the shaft.

8. The hydraulic damper of claim 1, further comprising:
an internal piston slidably disposed within the shaft.

9. The hydraulic damper of claim 1, further comprising:
a negative spring disposed between the shaft and the damper body.

10. A hydraulic damper comprising:
a damper body comprising a chamber; and
a flow control device disposed within the damper body, the flow control device comprising an orifice for enabling fluid flow therethrough, wherein the orifice comprises a curved edge flow inlet and a square edge flow inlet such that fluid flowing through the orifice from the curved edge flow inlet toward the square edge flow inlet exhibits a different pressure drop than fluid flowing through the orifice from the square edge flow inlet to the curved edge flow inlet.

11. The hydraulic damper of claim 10, wherein fluid flows through the orifice from the curved edge flow inlet toward the square edge flow inlet.

12. The hydraulic damper of claim 10, wherein fluid flows through the orifice from the square edge flow inlet to the curved edge flow inlet.

13. The hydraulic damper of claim 10, wherein the curved edge flow inlet comprises an elliptical cross section.

14. The hydraulic damper of claim 10, further comprising a bumper.

15. The hydraulic damper of claim 10, wherein said flow control device is coupled to an internal piston.

16. The hydraulic damper of claim 10, further comprising:
a negative spring disposed between the flow control device and the damper body.

17. A hydraulic damper comprising:
a damper body comprising a chamber;
a shaft telescopically engaged with the damper body;
a piston slidably disposed with the damper body and coupled to a first end of the shaft, the piston comprising an orifice for fluidly connecting the chamber to an interior of the shaft, wherein the orifice comprises an elliptical edge flow inlet and a square edge flow inlet such that fluid flowing through the orifice from the elliptical edge flow inlet toward the square edge flow inlet exhibits a different pressure drop than fluid flowing through the orifice from the square edge flow inlet to the elliptical edge flow inlet;
an internal piston slidably disposed within the shaft; and
a negative spring disposed between the shaft and the damper body.

18. The hydraulic damper of claim 17, wherein fluid flows through the orifice from the elliptical edge flow inlet toward the square edge flow inlet during a compression event.

19. The hydraulic damper of claim 17, wherein fluid flows through the orifice from the square edge flow inlet to the elliptical edge flow inlet during a rebound event.

20. The hydraulic damper of claim 17, further comprising a bumper disposed at a second end of the shaft.
